(19) United States
(12) Patent Application Publication
(10) Pub. No.: US 2013/0020516 A1
(43) Pub. Date: Jan. 24, 2013

(54) DUAL DIAPHRAGM VALVE

(71) Applicant: Walter J Kish, Las Vegas, NV (US)

(72) Inventor: Walter J Kish, Las Vegas, NV (US)

(73) Assignee: Norgren Kloehn, Inc., Las Vegas, NV (US)

(21) Appl. No.: 13/635,943

(22) PCT Filed: Apr. 5, 2010
(86) PCT No.: PCT/US10/29912

§ 371 Date: Sep. 19, 2012

(51) Int. Cl. F16K 31/06; F16K 11/07; F16K 43/00; F16K 7/16

(52) U.S. Cl. 251/129.17; 251/337; 137/625.48; 137/15.18; 137/15.21

(57) ABSTRACT

A dual diaphragm valve (100) includes a valve bore (40) extending between a first seal face (55) and a second seal face (56). A first port (36) and a second port (38) are in fluidic communication with the valve bore (40) through the first seal face (55) and the second seal face (56). The dual diaphragm valve (100) further includes a first diaphragm (47) positioned substantially at the first seal face (55), a second diaphragm (49) positioned substantially at the second seal face (56), and a valve plunger (24) configured to move substantially reciprocally in the valve bore (40). The first diaphragm (47) seals the first seal face (55) when the valve plunger (24) moves toward the second seal face (56) and the second diaphragm (49) seals the second seal face (56) when the valve plunger (24) moves toward the first seal face (55).

### BACKGROUND OF THE INVENTION

1. Field of the Invention

The invention is related to the field of valves, and more particularly, to a diaphragm valve.

2. Description of the Prior Art

Valves are used in a variety of applications. One type of valve is a diaphragm valve that regulates fluid flow by means of movement of a diaphragm to block a port or ports. A diaphragm valve can control a fluid flow independent of the direction of the flow. The diaphragm can be actuated by a solenoid, wherein the solenoid can be electrically energized and controlled to quickly and reliably actuate the valve.

Solenoid actuated valves are useful widely in remote areas, rugged environments and hazardous locations because they can be operated automatically. For this reason, they are used in a wide range of applications in many industries for controlling flow of fluids, including liquids and gases.

FIG. 1 shows a prior art diaphragm valve disclosed in U.S. Pat. No. 4,944,487 to Holtermann. The prior art diaphragm valve includes a plunger 2 configured to contact and seal against a valve seat 3. Ports 6 and 7 are located on either side of the valve seat 3. The plunger 2 is actuated in order to partially or completely open or close an aperture 4 using a flexible diaphragm 5, thereby controlling the fluid flow between ports 6 and 7. The aperture 4 is opened or closed by movement of the plunger 2 and the diaphragm 5, with the plunger 2 and diaphragm 5 moving toward and away from the valve seat 3. When the solenoid 9 is not energized, the spring 8 holds the plunger 2 to the right, subsequently blocking fluid passage between the ports 6 and 7 when the plunger 2 and the diaphragm 5 contact the seat 3. Conversely, when the solenoid 9 of the valve is energized, the plunger 2 is pulled to the left in the figure, against the spring 8 and away from the valve seat 3, opening the port 6 to the port 7.

In this prior art valve, the ports 6 and 7 are directly drilled through to the valve seat 3, thereby requiring that the valve seat 3 be of a certain surface area to meet the requirement of a specified flow rate. Because the prior art ports 6 and 7 are directly formed through to the valve seat 3, the cross-sectional area of the prior art valve must be sufficiently large to accommodate the desired flow rate. As a result, the cross-sectional area A of the prior art valve seat dictates not only the size of the diaphragm 5 but also dictates the force F needed to push the prior art diaphragm 5 against the valve seat 3, since the force F=P×A, wherein P is the fluid pressure inside the valve chamber. Accordingly, a large solenoid power is needed in order to apply a large force F to the diaphragm 5.

### ASPECTS OF THE INVENTION

In some aspects of the invention, a dual diaphragm valve comprises:
a valve bore extending between a first seal face and a second seal face, with at least a first port and a second port of the dual diaphragm valve being in fluidic communication with the valve bore through the first seal face and the second seal face;
a first diaphragm positioned substantially at the first seal face;
a second diaphragm positioned substantially at the second seal face; and
a valve plunger configured to move substantially reciprocally in the valve bore, wherein the first diaphragm is configured to substantially seal the first seal face when the valve plunger moves toward the second seal face and wherein the second diaphragm is configured to substantially seal the second seal face when the valve plunger moves toward the first seal face.

Preferably, the first port comprises a normally-open port and the second port comprises a normally-closed port.

Preferably, the dual diaphragm valve further comprises a common port in fluidic communication with the valve bore, wherein fluid travels between the common port and one of the first or second ports.

Preferably, the valve plunger is formed of a length such that the valve plunger remains in substantially abutting, substantially non-adherent contact with both the first and second diaphragms.

Preferably, the valve plunger has a cross-section that is substantially smaller than a cross-section of the valve bore.

Preferably, the valve plunger has a cross-sectional shape that allows fluid to flow substantially lengthwise along the valve plunger.

Preferably, the dual diaphragm valve further comprises a first inner groove positioned between and in communication with the first port and the first seal face and a second inner groove positioned between and in communication with the second port and the second seal face, wherein the first and second inner grooves are located substantially around the first and second seal faces and wherein the first and second ports intersect the first and second inner grooves.

Preferably, the first and second inner grooves comprise substantially annular grooves.

Preferably, the first and second ports further include first and second connecting channels that intersect the first and second inner grooves and are in fluidic communication therebetween.

Preferably, the first and second seal faces are shaped to substantially smoothly conduct fluid flow between the valve bore and the first and second inner grooves.

Preferably, the dual diaphragm valve further comprises a first spring configured to generate a first force F1, a push piece located between the first spring and the first diaphragm, with the first spring and the push piece pressing the first diaphragm against the first seal face when the valve plunger moves toward the second seal face under the influence of the first force F1, a second spring configured to generate a second force F2, an armature located between the second diaphragm and the second spring and opposite the valve plunger, with the second diaphragm being interposed between the armature and the valve plunger, with the second spring and the armature pressing the second diaphragm against the second seal face when the valve plunger moves toward the first seal face under the influence of the second force F2, and a solenoid configured to actuate the armature, wherein when the solenoid is energized, the armature moves substantially against the second spring and substantially with the first spring, wherein the solenoid moves the valve plunger toward the second diaphragm, substantially unblocking the second port and substantially blocking the first port and wherein when the solenoid is not energized, the second force from the second spring pushes the armature and the valve plunger to overcome the first force of the first spring, thereby unsealing the first seal face.

In some aspects of the invention, a dual diaphragm valve comprises:
a valve bore extending between a first seal face and a second seal face, with at least a first port and a second port of the dual diaphragm valve being in fluidic communication with the valve bore through the first seal face and the second seal face;
a first diaphragm positioned substantially at the first seal face;
a second diaphragm positioned substantially at the second seal face;
a valve plunger configured to move substantially reciprocally in the valve bore, wherein the first diaphragm is configured to substantially seal the first seal face when the valve plunger moves toward the second seal face and wherein the second diaphragm is configured to substantially seal the second seal face when the valve plunger moves toward the first seal face;
a first inner groove positioned between and in communication with the first port and the first seal face; and
a second inner groove positioned between and in communication with the second port and the second seal face, wherein the first and second inner grooves are located substantially around the first and second seal faces and the first and second ports intersect the first and second inner grooves.

Preferably, the first port comprises a normally-open port and the second port comprises a normally-closed port.

Preferably, the dual diaphragm valve further comprises a common port in fluidic communication with the valve bore, wherein fluid travels between the common port and one of the first or second ports, passing through the first and second inner grooves.

Preferably, the valve plunger is formed of a length such that the valve plunger remains in substantially abutting, substantially non-adherent contact with both the first and second diaphragms.

Preferably, the valve plunger has a cross-section that is substantially smaller than a cross-section of the valve bore.

Preferably, the valve plunger has a cross-sectional shape that allows fluid to flow substantially lengthwise along the valve plunger.

Preferably, the first and second inner grooves comprise substantially annular grooves.

Preferably, the first and second ports further include first and second connecting channels that intersect the first and second inner grooves and are in fluidic communication therebetween.

Preferably, the first and second seal faces are shaped to substantially smoothly conduct fluid flow between the valve bore and the first and second inner grooves.

Preferably, the dual diaphragm valve further comprises a first spring configured to generate a first force F1, a push piece located between the first spring and the first diaphragm, with the first spring and the push piece pressing the first diaphragm against the first seal face when the valve plunger moves toward the second seal face under the influence of the first force F1, a second spring configured to generate a second force F2, an armature located between the second diaphragm and the second spring and opposite the valve plunger, with the second diaphragm being interposed between the armature and the valve plunger, with the second spring and the armature pressing the second diaphragm against the second seal face when the valve plunger moves toward the first seal face under the influence of the second force F2, and a solenoid configured to actuate the armature, wherein when the solenoid is energized, the armature moves substantially against the second spring and substantially with the first spring, wherein the solenoid moves the valve plunger toward the second diaphragm, substantially unblocking the second port and substantially blocking the first port and wherein when the solenoid is not energized, the second force from the second spring pushes the armature and the valve plunger to overcome the first force of the first spring, thereby unsealing the first seal face.

In some aspects of the invention, a method of forming a dual diaphragm valve comprises:
providing a valve bore extending between a first seal face and a second seal face, with at least a first port and a second port of the dual diaphragm valve being in fluidic communication with the valve bore through the first seal face and the second seal face;
providing a first diaphragm positioned substantially at the first seal face;
providing a second diaphragm positioned substantially at the second seal face; and
providing a valve plunger configured to move substantially reciprocally in the valve bore, wherein the first diaphragm is configured to substantially seal the first seal face when the valve plunger moves toward the second seal face and wherein the second diaphragm is configured to substantially seal the second seal face when the valve plunger moves toward the first seal face.

Preferably, the method further comprises providing a first inner groove positioned between and in communication with the first port and the first seal face and providing a second inner groove positioned between and in communication with the second port and the second seal face, wherein the first and second inner grooves are located substantially around the first and second seal faces.

Preferably, the first and second inner grooves comprise substantially annular grooves.

Preferably, the first and second ports intersect the first and second inner grooves.

Preferably, the method further comprises forming the first and second ports into a valve body of the dual diaphragm valve and into fluidic communication with the first and second inner grooves, wherein the first and second ports intersect the first and second inner grooves.

Preferably, the method further comprises providing first and second connecting channels that intersect the first and second inner grooves and provide fluidic communication between the first and second ports and the first and second inner grooves.

Preferably, the method further comprises forming the first and second connecting channels into a valve body of the dual diaphragm valve and into fluidic communication with the first and second inner grooves, wherein the first and second connecting channels intersect the first and second inner grooves.

Preferably, the method further comprises shaping the first and second seal faces in order to substantially smoothly conduct fluid flow between the valve bore and the first and second inner grooves.

### BRIEF DESCRIPTION OF THE DRAWINGS

The same reference number represents the same element on all drawings. It should be understood that the drawings are not necessarily to scale.

FIG. 1 shows a prior art diaphragm valve.

FIG. 2 is a perspective view of a dual diaphragm valve according to an embodiment of the invention.

FIG. 3 is an exploded view of the dual diaphragm valve according to an embodiment of the invention.

FIG. 4 is a cross-sectional view AA of the dual diaphragm valve according to an embodiment of the invention.

FIG. 5 is a cross-sectional view that shows the dual diaphragm valve in a substantially non-actuated mode, wherein the solenoid is not energized.

FIG. 6 is a cross-sectional view that shows the dual diaphragm valve in a substantially actuated configuration, wherein the solenoid is energized.

FIG. 7 shows a valve plunger of the dual diaphragm valve according to an embodiment of the invention.

FIG. 8 shows a partial section perspective view of the dual diaphragm valve in according to an embodiment of the invention.

FIG. 9 shows the valve plunger according to the invention.

### DETAILED DESCRIPTION OF THE INVENTION

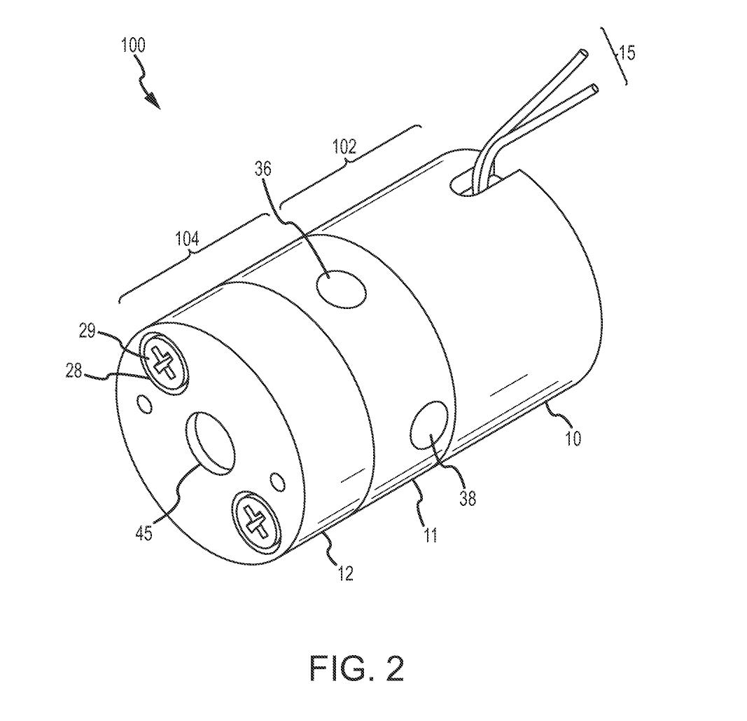

FIGS. 2-9 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

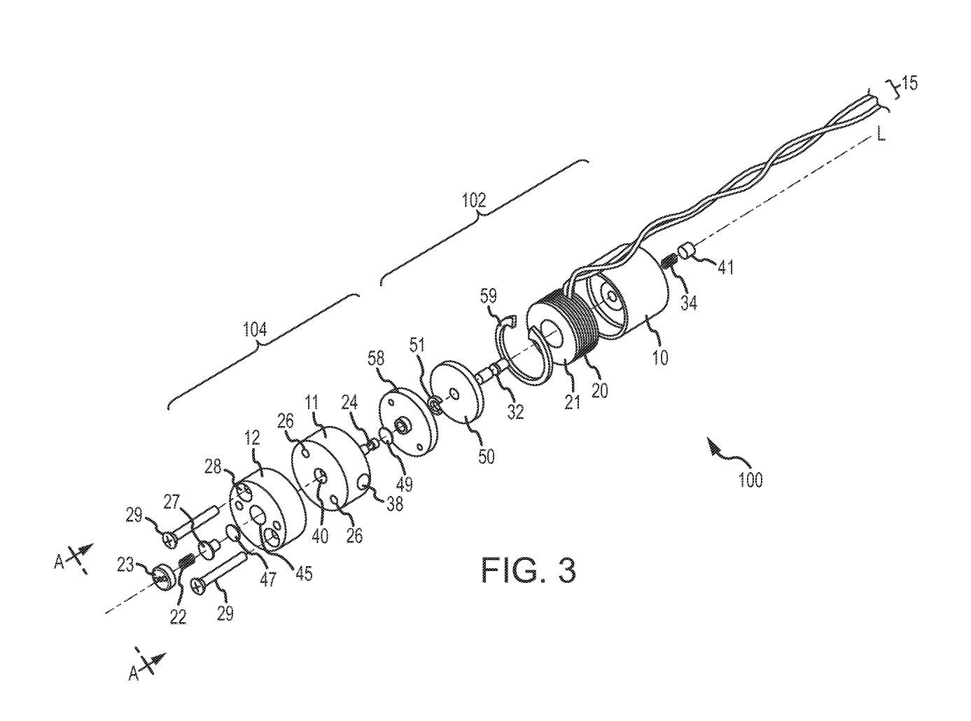

FIG. 2 is a perspective view of a dual diaphragm valve 100 according to an embodiment of the invention. The dual diaphragm valve 100 comprises a solenoid 102 and a valve 104. The solenoid 102 includes a coil housing 10 and wires 15. The solenoid 102 can be energized via the wires 15. Additional components of the solenoid 102 are shown in FIGS. 3-7 and are discussed below.

The valve 104 includes a valve body 11 and an end cap 12. The valve body 11 includes at least a first port 36 and a second port 38. It should be understood that the valve body 11 can include additional ports in some embodiments, such as a common port 42 (not shown). The first and second ports 36 and 38 open to the exterior of the dual diaphragm valve 100 and can receive or mate with any manner of fluid-conducting conduits. The valve 104 in some embodiments comprises a two port, one-way valve, where passage between the first port 36 and the second port 38 can be selectively blocked and unblocked. The valve 104 in some embodiments comprises a three port, two-way valve, where one or the other of the first port 36 or the second port 38 are connected by a valve mechanism to a common port 42.

The end cap 12 includes a spring bore 45 for inserting/accessing valve components including a first spring 22. The end cap 12 further includes one or more fastener apertures 28 and one or more corresponding fasteners 29. The one or more fasteners 29 can affix (or removably affix) the valve body 11 to the end cap 12.

The dual diaphragm valve 100 can be substantially cylindrical, as shown. However, it should be understood that the dual diaphragm valve 100 can be other shapes. The dual diaphragm valve 100 is compact and small.

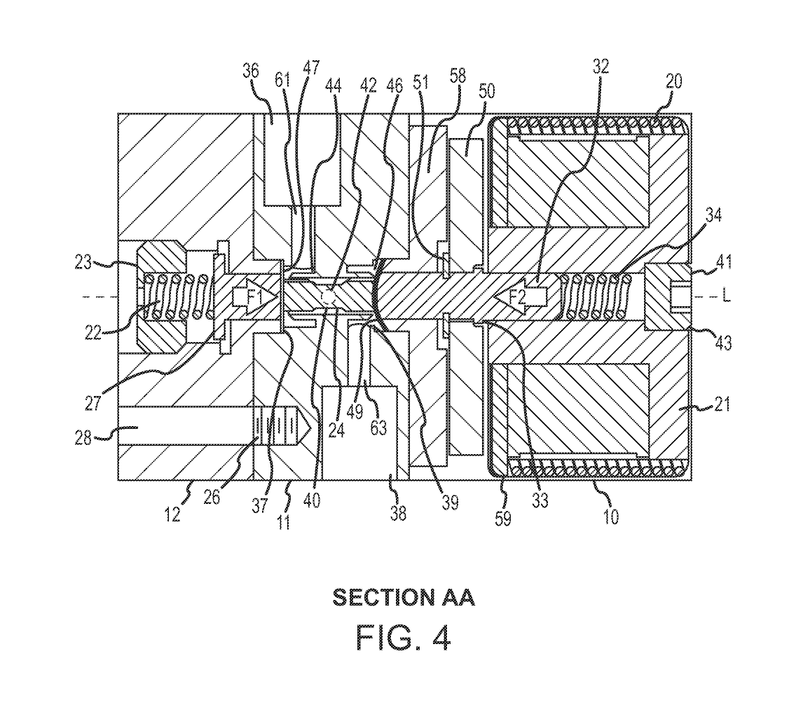

FIG. 3 is an exploded view of the dual diaphragm valve 100 according to an embodiment of the invention. The solenoid 102 comprises a coil housing 10, a bobbin 21, a coil 20 wound on the bobbin 21, a bobbin retainer 59 that holds the bobbin 21 and the coil 20 in the coil housing 10, a second spring 34 that resides in the solenoid 102, and a second spring retainer 41. In a preferred embodiment, the solenoid coil 20 comprises copper coils and the bobbin 21 in some embodiments comprises plastic. The second spring retainer 41 affixes to an aperture 43 in the coil housing 10 (see FIG. 4) and retains the second spring 34 inside the solenoid 102. The solenoid 102 further comprises an armature 32 that resides at least partially within the solenoid 102. The armature 32 is pulled into the coil 20 when the coil 20 is energized, against a second force F2 created by the second spring 34. Consequently, the coil 20 pulls the armature 32 to the right in the figure when energized. When the coil 20 is not energized, then the second spring 34 will push the armature 32 towards the left.

A portion of the armature 32 passes through an armature disk 50. The armature disk 50 can be formed of a magnetic or magnetically responsive material, wherein the armature disk 50 is pulled to the right in the figure when the solenoid 102 is energized. The armature 32 can likewise be formed of a magnetic or magnetically responsive material and includes a ridge 33 that is contacted by the armature disk 50, wherein magnetic force acting on the armature disk 50 is transferred to the armature 32 via the ridge 33. A disk retainer 51 further attaches to the armature 32 and holds the armature disk 50 substantially against the ridge 33.

The coil housing 10, the valve body 11, and the end cap 12 together define a central longitudinal axis L. The coil housing 10, the valve body 11, and the end cap 12 are all disposed along the axis L and therefore are substantially coaxial. In a preferred embodiment, the valve body 11 is composed of a polymer, such as Polyetheretherketon (PEEK) or KEL-F. The end cap 12 may be made of aluminum. However, other materials are contemplated and are within the scope of the description and claims.

The valve body 11 includes a valve bore 40, the first and second ports 36 and 38, and a common port 42. A valve plunger 24 resides in the valve bore 40 and can move substantially reciprocally within the valve bore 40. A first diaphragm 47 is located in the valve bore 40 adjacent to the end cap 12 (the figure does not necessarily show components in a final, assembled order, see FIGS. 4-6). The push piece 27 contacts the first diaphragm 47 and can move the first diaphragm 47 (in conjunction with the valve plunger 24). A diaphragm keeper 58 receives a portion of the armature 32, where the armature 32 and the diaphragm keeper 58 hold a second diaphragm 49 in an opposite end of the valve bore 40. The valve body 11 can further comprise one or more fastener receiving apertures 26.

The end cap 12 includes the spring bore 45 and one or more fastener apertures 28 that correspond to the one or more fastener receiving apertures 26 of the valve body 11. Fasteners 29 can pass through the fastener apertures 28 and engage the fastener receiving apertures 26 in the valve body 11, thereby affixing the end cap 12 to the valve body 11. Further, the end cap 12 includes the push piece 27 located in the spring bore 45, along with a first spring 22, and a first spring retainer 23. The first spring retainer 23 affixes to the end cap 12 and in some embodiments retains the first spring 22 and the push piece 27 in the spring bore 45.

In a preferred embodiment, the diaphragms 47 and 49 are preferably composed of elastic and flexible material, such as EPDM (ethylene propylene diene monomer rubber), Viton Elastomers, or Perflouroelastomers. The valve plunger 24 may be composed of a polymer, such as Polyetheretherketon (PEEK) or Kel-F. In a preferred embodiment, the first spring 22, the second spring 34, and the armature 32 are composed of stainless steel. The coil housing 13 and the armature disk 50 are preferably composed of a magnetic stainless steel, such as 430 FR. However, other materials are contemplated for the components of the dual diaphragm valve 100 and are within the scope of the description and claims.

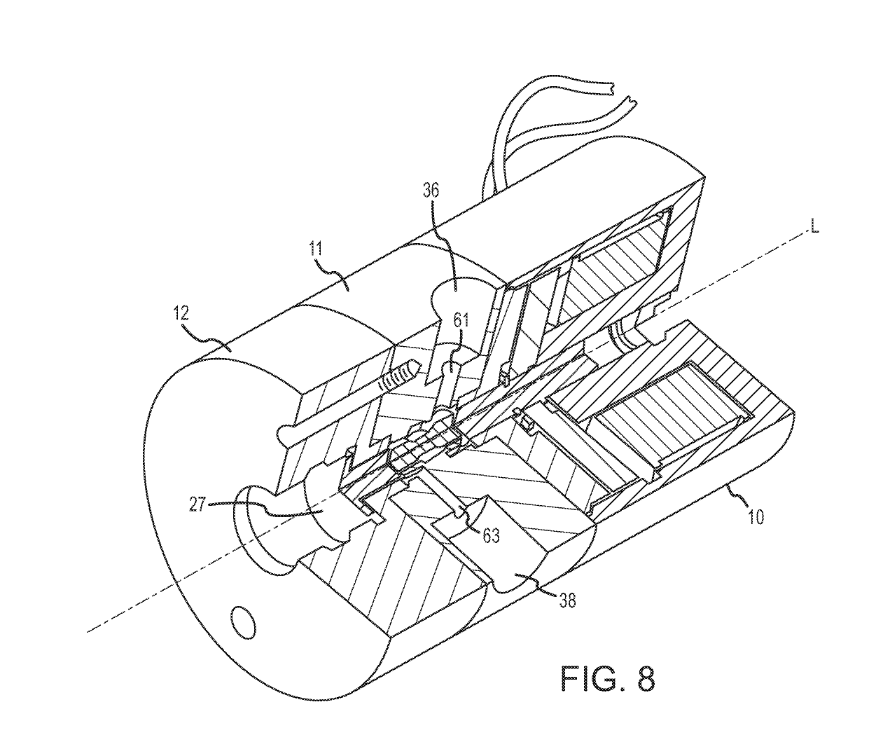

FIG. 4 is a cross-sectional view AA of the dual diaphragm valve 100 according to an embodiment of the invention. The first and second ports 36 and 38 in this figure are shown as being somewhere between forty-five and one hundred eighty degrees apart in angular displacement. This should be understood to be merely one embodiment. The second port 38 can be spaced at any angular position relative to the first port 36 (see FIG. 8). The section is not necessarily planar, and can include two section faces, depending on the orientation of the various components. In addition, this figure shows the arrangement and interaction of the various moving valve components.

The end cap 12 holds and substantially encloses the first spring 22 and the push piece 27, trapping the first diaphragm 47 against a first sealing surface 37 of the valve body 11. The first sealing surface 37 receives a perimeter portion of the first diaphragm 47 and the second sealing surface 39 receives a perimeter portion of the second diaphragm 49. The first spring 22 is disposed adjacent the push piece 27 along the axis L and generates a first force F1 against the push piece 27. The armature 32 and the diaphragm keeper 58 together trap the second diaphragm 49 against a second sealing surface 39 of the valve body 11. The second sealing surface 39 is substantially opposing the first sealing surface 37 in the valve bore 40, on opposing ends of the valve plunger 24.

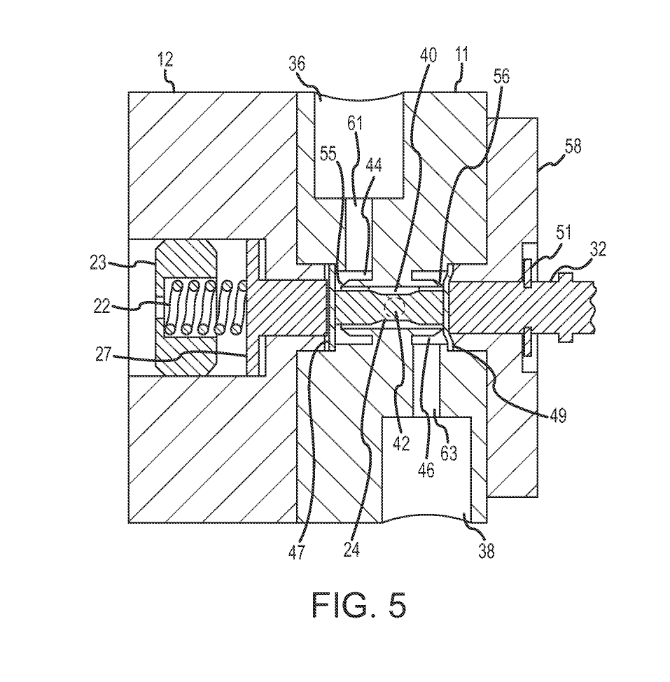

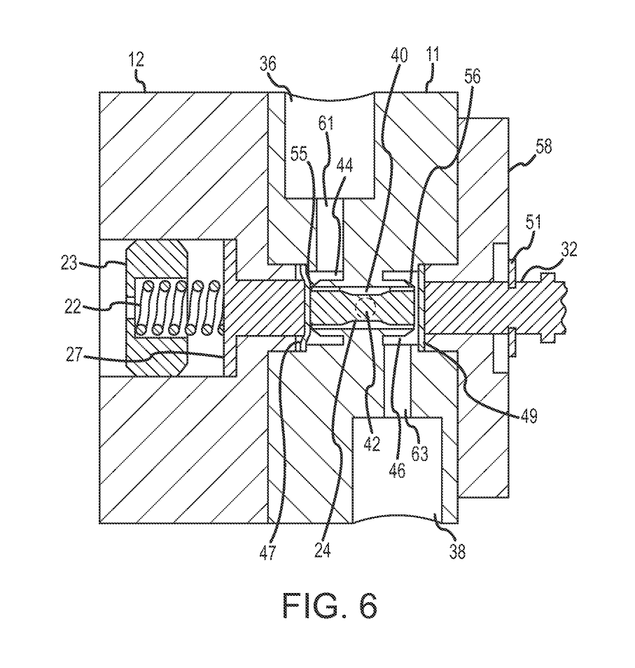

The armature 32 extends through the coil housing 10, the armature disk 50, and the diaphragm keeper 58. The armature 32, the armature disk 50, and the diaphragm keeper 58 can move substantially reciprocally when the coil 20 is energized and de-energized (see FIGS. 5-6). However, the movement is also constrained by the first spring 22 and the second spring 34. The first spring 22 urges the armature 32 to the right in the figure due to the generated first force 51. However, the second spring 34 urges the armature 32 to the left due to the generated second force F2.

The first force F1 generated by the first spring 22 and the second force F2 generated by the second spring 34 are both preferably in a linear regime. That is, the first force F1 and the second force F2 may be proportional to a length change of the spring as the spring is being compressed. The first force F1 and the second force F2 are substantially opposite. The first force F1 and the second force F2 are arranged so that the first port 36 and the first diaphragm 47 are substantially open when the solenoid 102 is energized while the second diaphragm 49 is not. Consequently, the forces F1 and F2 can be substantially balanced when the solenoid 102 is in a non-energized state.

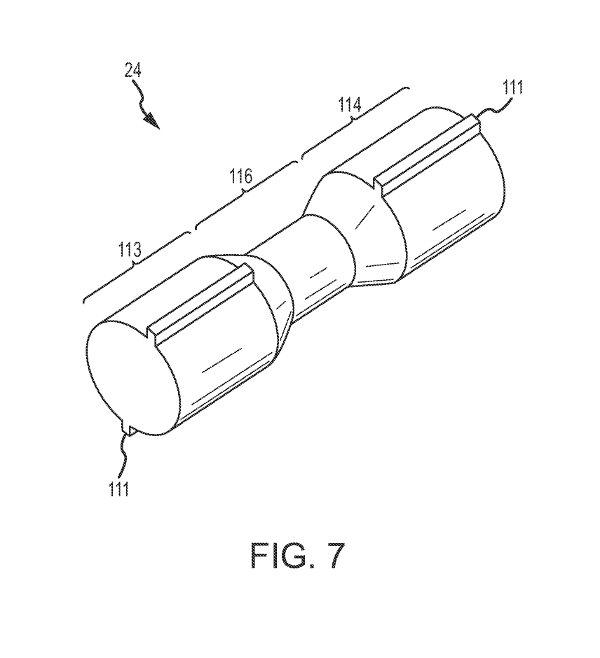

The figure shows the first and second ports 36 and 38 opening to the exterior of the dual diaphragm valve 100. The valve body 11 includes a first connecting channel 61 that communicates the first port 36 to the valve bore 40. Likewise, a second connecting channel 63 communicates the second port 38 to the valve bore 40. The common port 42 (hidden lines) communicates directly between the valve bore 40 and the exterior of the dual diaphragm valve 100, such as to any manner of conduit, etc. The common port 42 in some embodiments opens to the valve bore 40 at about a neck region 116 of the valve plunger 24 (see FIG. 7). The neck region 116 allows a greater fluid flow through the valve bore. The neck region 116 can also reduce turbulence and associated fluid drag.

The first port 36 in one embodiment has a substantially circular cross-section and the first connecting channel 61 likewise has a substantially circular cross-section. However, any desired cross-sectional shape can be employed. As shown, the major dimension of the first port 36 (such as a diameter, for example) is greater than the major dimension of the first connecting channel 61 in some embodiments. This may be done to receive and/or accommodate any manner of external fitting or coupler. This can also be true for the second port 38 and the second connecting channel 63. However, those of ordinary skill in the art will recognize that the first and second ports 36 and 38 may have identical or different dimensions and that the first and second connecting channels 61 and 63 and may also have identical or different dimensions.

A valve bore 40 extends through the valve body 11 from the first port 36 to the second port 38 and is in fluidic communication with both ports 36 and 38. A common port 42 is in fluidic connection with the valve bore 40 and extends to an exterior of the dual diaphragm valve 100. Fluid entering the valve 100 from the common port 42 can therefore be selectively dispensed from either the first port 36 or the second port 38, depending on the actuation state of the valve 100. Conversely, one of the first and second ports 36 and 38 can be selected as an input, and the fluid entering the selected input can be output from the common port 42.

The valve body 11 may further include inner grooves 44 and 46. The inner grooves 44 and 46 in some embodiments comprise annular grooves. However, the inner grooves 44 and 46 can comprise other shapes and configurations. The inner grooves 44 and 46 respectively communicate between the first and second connecting channels 61 and 63 and the valve bore 40. Fluid can travel between the common port 42 and the first and second ports 36 and 38 through the inner grooves 44 and 46.

The first and second connecting channels 61 and 63 connect the first and second ports 36 and 38 to the first and second inner grooves 44 and 46. In some embodiments, the first and second connecting channels 61 and 63 are directly formed or opened from the first and second ports 36 and 38 to the first and second inner grooves 44 and 46, such as by drilling or boring in some manner. However, the first and second connecting channels 61 and 63 can be formed in other manners.

The valve plunger 24 is disposed in the valve bore 40 between the first diaphragm 47 and the second diaphragm 49. In a preferred embodiment, the length of the valve plunger 24 is selected such that the valve plunger 24 remains in an abutting (but non-adherent) contact with both the first and the second diaphragms 47 and 49 at their inward sides, i.e., the sides facing the common port 42. The outward side of the first diaphragm 47 is in contact with the push piece 27, which is biased by the first spring 22. The outward side of the second diaphragm 49 is in contact with the armature 32, which is biased by the second spring 34.

The first port 36 is in fluidic communication with a first sealing surface 37 surrounding the valve bore 40 and the second port 38 is in fluidic communication with a second sealing surface 39 surrounding the valve bore 40. The first sealing surface 37 is configured to receive the first diaphragm 47 and the second sealing surface 39 is configured to receive the second diaphragm 49.

By having the first and second ports 36 and 38 intersect and connect directly to the first and second annular grooves 44 and 46, smaller diaphragms are needed to seal the first and second seal faces 55 and 56, as compared with those found in prior art valves. The result is that the dual diaphragm valve 100 requires less strong and/or less resilient materials for the diaphragms 47 and 49. Smaller diaphragms result in smaller actuation forces and less electrical consumption.

Prior art valves having a valve body that contains the inlet and outlet directly on the face of the valve (or valve seat) usually require a diaphragm of at least 0.430 inches in diameter. In one embodiment of the dual diaphragm valve 100 according to the invention, the first and second diaphragms 47 and 49 have a diameter of less than 0.430 inch, and preferably about approximately 0.200 inch. This decrease in diaphragm size and/or diaphragm area results in a decrease of the force needed to actuate the valve. Due to the decrease in the force, the valve can function at a drastically reduced power. However, larger diaphragm sizes can also be employed as needed, and are within the scope of the description and claims.

In a preferred embodiment, use of the present invention in a valve assembly may result in at least a forty percent power reduction. The substantial decrease in power allows the present invention to be used in portable medical equipment that runs on a battery, as opposed to a power generator, and thereby allows the valve to be more transportable.

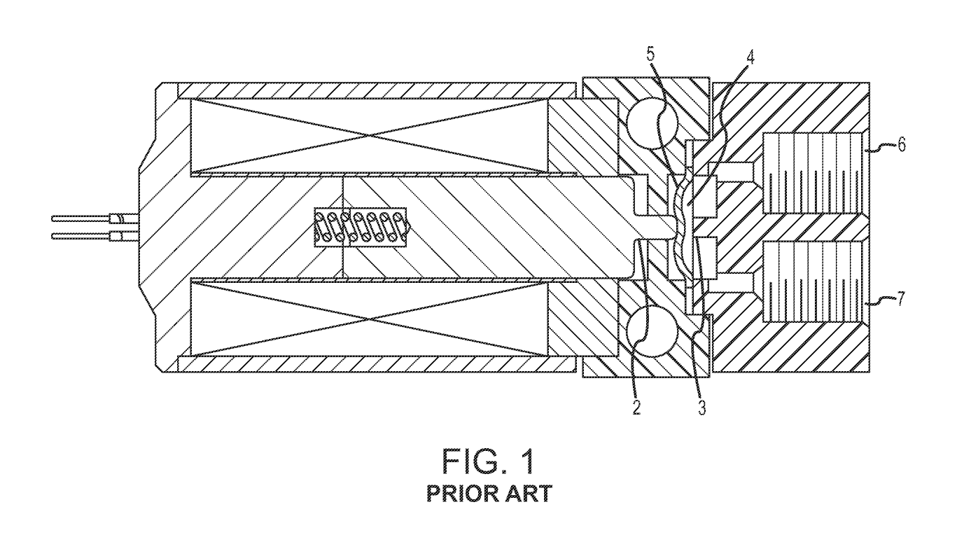

Referring again to the prior art diaphragm valve of FIG. 1, in the prior art the ports are directly drilled into the valve seat. As a result, a backpressure acting against the spring 8 in the absence of solenoid energization (i.e., a pressure acting to open the diaphragm element), is normally rated at approximately fifty percent of the pressure rating that can be controlled by the prior art diaphragm valve.

In the dual diaphragm valve 100 according to the invention, pressures between the common port 42 and the first port 36 and the second port 38 are more balanced as compared with prior art diaphragm valves. However, embodiments of the invention are capable of accommodating a backpressure of approximately seventy-five percent of the pressure at the common port 42. The first diaphragm 47 or the second diaphragm 49 accomplishes the pressure seal from the common port 42 by sealing against a smaller area. In other words, a smaller diaphragm results in a smaller required sealing force, in either flow direction, since the force F=P×A, as discussed earlier. The smaller the diameter of the diaphragm, the more pressure the valve 100 can seal with the same applied force.

FIG. 5 is a cross-sectional view that shows the dual diaphragm valve 100 in a substantially non-actuated mode wherein the solenoid 102 is not energized. This can also be termed a normally-closed state of the second port 38, wherein the dual diaphragm valve 100 will keep the first port 36 open and the second port 38 closed in the absence of electrical energization. In the embodiment shown, the armature 32, acting under the second force F2 from the second spring 34, presses against the second diaphragm 49, which in turn compresses against the second seal face 56 and thereby seals off the second port 38. The second diaphragm 49 contacts both the second sealing surface 39 and the seal face 55. Consequently, the second inner groove 46 is completely sealed off and no fluid enters or leaves the second inner groove 46. The armature 32 also pushes the valve plunger 24 toward the end cap 12 and against the push piece 27. The push piece 27 is balanced by the first force F1 of the first spring 22 and presses against the first diaphragm 47. Such balancing forces F1 and F2 allow greater pressure to be attained within the valve 100 with less power and significantly less internal volume.

In addition, the valve plunger 24 is moved by the second spring 34 to push the first (i.e., normally-open) diaphragm 47 into an open position, away from the first seal face 55, as the second spring 34 overcomes the first spring 22. Conversely, the first port 36 is left open. As a result, fluid can travel between the common port 42 and the first port 36 in either direction.

The first and second seal faces 55 and 56 are shaped to substantially smoothly conduct fluid flow between the valve bore 40 and the first and second inner grooves 44 and 46. The seal face can be substantially rounded, as shown by the first seal face 55. Alternatively, the seal face 55 can be substantially angled or beveled, as shown by the second seal face 56. Either the at least partially rounded or the at least partially angled seal face can be used in order to reduce and minimize turbulence in the fluid as it flows between the common port 42 and the selected port 36 or 38.

FIG. 6 is a cross-sectional view that shows the dual diaphragm valve 100 in a substantially actuated configuration, wherein the solenoid 102 is energized. When the coil 20 is energized, the valve plunger 24 and the armature disk 50 are pulled back towards the coil 20, compressing the second spring 34 and relieving the compression of the first spring 22. The movement of the armature 32 causes the valve plunger 24 to also move to the right. As a consequence, the push piece 27 also moves to the right under the influence of the first spring 22, following the valve plunger 24. The first spring 22 consequently moves the push piece 27 to the right and seals the first (i.e., normally open) port 36, sealingly contacting the first diaphragm 47 against the first seal face 55. In response to the movement of the push piece 27, the valve plunger 24 pushes the second (i.e., normally-closed) diaphragm 49 to an open position, unblocking the second seal face 56. As a result, the first port 36 is closed and the second port 38 is opened. Meanwhile, the movement of the armature 32 and the valve plunger 24 moves the second diaphragm 49 away from sealing contact with the second seal face 56, opening the second inner groove 46. As a result, fluid can travel between the common port 42 and the second port 38 in either direction.

FIG. 7 shows the valve plunger 24 of the dual diaphragm valve 100 according to an embodiment of the invention. The valve plunger 24 has a cross-section that is substantially smaller than a cross-section of the valve bore 40. This design permits fluids to flow around the valve plunger 24 within the valve bore 40, and through the first and second ports 36 and 38.

The cross-sectional shape of the valve plunger 24 is shown in the figure to be substantially circular. However, it should be understood that other cross-sectional shapes are contemplated and are within the scope of the description and claims.

In the embodiment shown, the valve plunger 24 includes substantially elongate end portions 113 and 114, a neck region 116, and one or more standoff projections 111 on each of the end portions 113 and 114. The neck region 116 comprises a reduction in cross-sectional size, wherein the neck region 116 is substantially located corresponding to the common port 42. The neck region 116 therefore accommodates fluid flow into or out of the common port 42 and through the valve bore 40. The neck region 116 can further accommodate the fluid flow and reduce turbulence in the region of the common port 42.

The one or more standoff projections 111 contact the walls of the valve bore 40 and therefore hold the valve plunger 24 in a substantially centered position in one embodiment. However, the valve plunger 24 does not have to necessarily be centered. Further, the one or more standoff projections 111 can allow fluid flow around the valve plunger 24 and through the valve bore 40. Two standoff projections 111 are shown on each of the end portions 113 and 114, but it should be understood that any number of standoff projections 111 can be employed.

FIG. 8 shows a partial section perspective view of the dual diaphragm valve 100 in accordance with an embodiment of the invention. Approximately one-quarter of the valve 100 has been removed. In this embodiment, the second port 38 is located on the exterior of the valve 100 approximately forty-five degrees from the first port 36. However, as previously discussed, the two ports can be located at any desired degree of separation. In addition, the figure also shows that the relative positions of the ports can be swapped or moved.

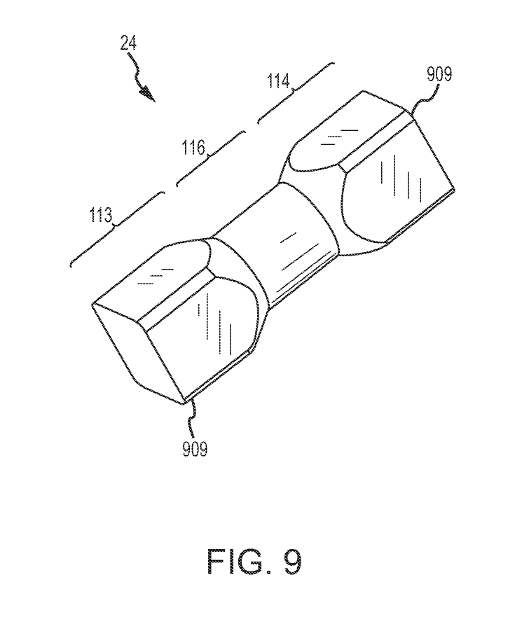

FIG. 9 shows the valve plunger 24 according to the invention. In this embodiment, the valve plunger 24 includes the substantially elongate end portions 113 and 114 and the neck region 116. However, instead of projections 111, in this embodiment the end portions 113 and 114 have substantially square cross-sections. The cross-sections may be modified by bevels 909. Consequently, fluid may flow substantially lengthwise along the valve plunger 24 and along the end portions 113 and 114 in the regions of the flat surfaces. It should be understood that a square cross-section is only one possibility. Alternatively, the end portions could be formed in other non-circular cross-sections.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention should be determined from the following claims.

We claim:

1. A dual diaphragm valve (100), comprising:
a valve bore (40) extending between a first seal face (55) and a second seal face (56), with at least a first port (36) and a second port (38) of the dual diaphragm valve (100) being in fluidic communication with the valve bore (40) through the first seal face (55) and the second seal face (56);
a first diaphragm (47) positioned substantially at the first seal face (55);
a second diaphragm (49) positioned substantially at the second seal face (56); and
a valve plunger (24) configured to move substantially reciprocally in the valve bore (40), wherein the first diaphragm (47) is configured to substantially seal the first seal face (55) when the valve plunger (24) moves toward the second seal face (56) and wherein the second diaphragm (49) is configured to substantially seal the second seal face (56) when the valve plunger (24) moves toward the first seal face (55).

2. The dual diaphragm valve (100) of claim 1, wherein the first port (36) comprises a normally-open port and the second port (38) comprises a normally-closed port.

3. The dual diaphragm valve (100) of claim 1, further comprising a common port (42) in fluidic communication with the valve bore (40), wherein fluid travels between the common port (42) and one of the first or second ports (36, 38).

4. The dual diaphragm valve (100) of claim 1, wherein the valve plunger (24) is formed of a length such that the valve plunger (24) remains in substantially abutting, substantially non-adherent contact with both the first and second diaphragms (47, 49).

5. The dual diaphragm valve (100) of claim 1, wherein the valve plunger (24) has a cross-section that is substantially smaller than a cross-section of the valve bore (40).

6. The dual diaphragm valve (100) of claim 1, wherein the valve plunger (24) has a cross-sectional shape that allows fluid to flow substantially lengthwise along the valve plunger (24).

7. The dual diaphragm valve (100) of claim 1, further comprising:
a first inner groove (44) positioned between and in communication with the first port (36) and the first seal face (55); and
a second inner groove (46) positioned between and in communication with the second port (38) and the second seal face (56), wherein the first and second inner grooves (44, 46) are located substantially around the first and second seal faces (55, 56) and wherein the first and second ports (36, 38) intersect the first and second inner grooves (44, 46).

8. The dual diaphragm valve (100) of claim 7, wherein the first and second inner grooves (44, 46) comprise substantially annular grooves.

9. The dual diaphragm valve (100) of claim 7, wherein the first and second ports (36, 38) further include first and second connecting channels (61, 63) that intersect the first and second inner grooves (44, 46) and are in fluidic communication therebetween.

10. The dual diaphragm valve (100) of claim 7, wherein the first and second seal faces (55, 56) are shaped to substantially smoothly conduct fluid flow between the valve bore (40) and the first and second inner grooves (44, 46).

11. The dual diaphragm valve (100) of claim 1, further comprising:
a first spring (22) configured to generate a first force F1;
a push piece (27) located between the first spring (22) and the first diaphragm (47), with the first spring (22) and the push piece (27) pressing the first diaphragm (47) against the first seal face (55) when the valve plunger (24) moves toward the second seal face (56) under the influence of the first force F1;
a second spring (34) configured to generate a second force F2;
an armature (32) located between the second diaphragm (49) and the second spring (34) and opposite the valve plunger (24), with the second diaphragm (49) being interposed between the armature (32) and the valve plunger (24), with the second spring (34) and the armature (32) pressing the second diaphragm (49) against the second seal face (56) when the valve plunger (24) moves toward the first seal face (55) under the influence of the second force F2; and
a solenoid (102) configured to actuate the armature (32), wherein when the solenoid (102) is energized, the armature (32) moves substantially against the second spring (34) and substantially with the first spring (22), wherein the solenoid (102) moves the valve plunger (24) toward the second diaphragm (49), substantially unblocking the second port (38) and substantially blocking the first port (36) and wherein when the solenoid (102) is not energized, the second force from the second spring (34) pushes the armature (32) and the valve plunger (24) to overcome the first force of the first spring (22), thereby unsealing the first seal face (55).

12. A dual diaphragm valve (100), comprising:
a valve bore (40) extending between a first seal face (55) and a second seal face (56), with at least a first port (36) and a second port (38) of the dual diaphragm valve (100) being in fluidic communication with the valve bore (40) through the first seal face (55) and the second seal face (56);
a first diaphragm (47) positioned substantially at the first seal face (55);
a second diaphragm (49) positioned substantially at the second seal face (56);
a valve plunger (24) configured to move substantially reciprocally in the valve bore (40), wherein the first diaphragm (47) is configured to substantially seal the first seal face (55) when the valve plunger (24) moves toward the second seal face (56) and wherein the second diaphragm (49) is configured to substantially seal the second seal face (56) when the valve plunger (24) moves toward the first seal face (55);
a first inner groove (44) positioned between and in communication with the first port (36) and the first seal face (55); and
a second inner groove (46) positioned between and in communication with the second port (38) and the second seal face (56), wherein the first and second inner grooves (44, 46) are located substantially around the first and second seal faces (55, 56) and the first and second ports (36, 38) intersect the first and second inner grooves (44, 46).

13. The dual diaphragm valve (100) of claim 12, wherein the first port (36) comprises a normally-open port and the second port (38) comprises a normally-closed port.

14. The dual diaphragm valve (100) of claim 12, further comprising a common port (42) in fluidic communication with the valve bore (40), wherein fluid travels between the common port (42) and one of the first or second ports (36, 38), passing through the first and second inner grooves (44, 46).

15. The dual diaphragm valve (100) of claim 12, wherein the valve plunger (24) is formed of a length such that the valve plunger (24) remains in substantially abutting, substantially non-adherent contact with both the first and second diaphragms (47, 49).

16. The dual diaphragm valve (100) of claim 12, wherein the valve plunger (24) has a cross-section that is substantially smaller than a cross-section of the valve bore (40).

17. The dual diaphragm valve (100) of claim 12, wherein the valve plunger (24) has a cross-sectional shape that allows fluid to flow substantially lengthwise along the valve plunger (24).

18. The dual diaphragm valve (100) of claim 12, wherein the first and second inner grooves (44, 46) comprise substantially annular grooves.

19. The dual diaphragm valve (100) of claim 12, wherein the first and second ports (36, 38) further include first and second connecting channels (61, 63) that intersect the first and second inner grooves (44, 46) and are in fluidic communication therebetween.

20. The dual diaphragm valve (100) of claim 12, wherein the first and second seal faces (55, 56) are shaped to substantially smoothly conduct fluid flow between the valve bore (40) and the first and second inner grooves (44, 46).

21. The dual diaphragm valve (100) of claim 12, further comprising:
a first spring (22) configured to generate a first force F1;
a push piece (27) located between the first spring (22) and the first diaphragm (47), with the first spring (22) and the push piece (27) pressing the first diaphragm (47) against the first seal face (55) when the valve plunger (24) moves toward the second seal face (56) under the influence of the first force F1;
a second spring (34) configured to generate a second force F2;
an armature (32) located between the second diaphragm (49) and the second spring (34) and opposite the valve plunger (24), with the second diaphragm (49) being interposed between the armature (32) and the valve plunger (24), with the second spring (34) and the armature (32) pressing the second diaphragm (49) against the second seal face (56) when the valve plunger (24) moves toward the first seal face (55) under the influence of the second force F2; and
a solenoid (102) configured to actuate the armature (32), wherein when the solenoid (102) is energized, the armature (32) moves substantially against the second spring (34) and substantially with the first spring (22), wherein the solenoid (102) moves the valve plunger (24) toward the second diaphragm (49), substantially unblocking the second port (38) and substantially blocking the first port (36) and wherein when the solenoid (102) is not energized, the second force from the second spring (34) pushes the armature (32) and the valve plunger (24) to overcome the first force of the first spring (22), thereby unsealing the first seal face (55).

22. A method of forming a dual diaphragm valve, the method comprising:
providing a valve bore extending between a first seal face and a second seal face, with at least a first port and a second port of the dual diaphragm valve being in fluidic communication with the valve bore through the first seal face and the second seal face;
providing a first diaphragm positioned substantially at the first seal face;
providing a second diaphragm positioned substantially at the second seal face; and
providing a valve plunger configured to move substantially reciprocally in the valve bore, wherein the first diaphragm is configured to substantially seal the first seal face when the valve plunger moves toward the second seal face and wherein the second diaphragm is configured to substantially seal the second seal face when the valve plunger moves toward the first seal face.

23. The method of claim 22, further comprising:
providing a first inner groove positioned between and in communication with the first port and the first seal face; and
providing a second inner groove positioned between and in communication with the second port and the second seal face, wherein the first and second inner grooves are located substantially around the first and second seal faces.

24. The method of claim 23, wherein the first and second inner grooves comprise substantially annular grooves.

25. The method of claim 23, wherein the first and second ports intersect the first and second inner grooves.

26. The method of claim 23, further comprising forming the first and second ports into a valve body of the dual diaphragm valve and into fluidic communication with the first and second inner grooves, wherein the first and second ports intersect the first and second inner grooves.

27. The method of claim 23, further comprising providing first and second connecting channels that intersect the first and second inner grooves and provide fluidic communication between the first and second ports and the first and second inner grooves.

28. The method of claim 27, further comprising forming the first and second connecting channels into a valve body of the dual diaphragm valve and into fluidic communication with the first and second inner grooves, wherein the first and second connecting channels intersect the first and second inner grooves.

29. The method of claim 23, further comprising shaping the first and second seal faces in order to substantially smoothly conduct fluid flow between the valve bore and the first and second inner grooves.
